(19) United States
(12) Patent Application Publication
(10) Pub. No.: US 2002/0003999 A1
(43) Pub. Date: Jan. 10, 2002

(54) Discharge and stacker device

(76) Inventors: Claus Bonde, Hornslet (DK); Niels Bjarne Hundtofte, Arhus C (DK); Jacob Winther, Aalborg (DK)

Correspondence Address: BIRCH STEWART KOLASCH & BIRCH, PO BOX 747, FALLS CHURCH, VA, 22040-0747, US

(21) Appl. No.: 09/801,737

(22) Filed: Mar. 9, 2001

(30) Foreign Application Priority Data
Mar. 9, 2000 (DK) PA 2000 00390

(51) Int. Cl. G06F 7/00; B65G 57/06

(52) U.S. Cl. 414/790.9; 700/226

(57) ABSTRACT

A discharge device and a method of discharging an article. During discharge the article is kept in a holding position and in a holding orientation by holding means. The holding means is movable between an article supporting position and a non-supporting position, the movement being performed swiftly so that the article maintains the holding orientation during the remaining part of the discharge. The orientation of the articles is thereby controlled. The discharge device comprises at least two receiving stations, and for each article a corresponding receiving station may be selected, e.g. according to final destination, size, shape and/or nature of the article. Well suited for discharging articles of substantially homogeneous size and shape, such as CD's, video cassettes, tape cassettes, books etc. May be adapted for discharging a number of different kinds of articles. Saves space because two or more receiving stations are connected to one discharge device.

The present invention relates to a discharge and stacker device for discharging and stacking articles, in particular substantially flat articles. The invention further relates to a sorting device which makes it possible to shift between a number of different receiving stations all being connected to the same discharge device. The present invention relates even further to a method of discharging and stacking articles using a discharge device according to the invention.

### BACKGROUND

It is known to have a discharge device which is stacking articles in substantially vertical stacks by moving the articles in a substantially horizontal direction onto the stack, the stack being subsequently lowered so as to make it possible for the following article to be moved horizontally onto the stack at the same level as the previous article was moved onto the stack.

It is also know to have a discharge and stacker device which stacks the articles horizontally. However, this type of stacking makes it complicated to have different receiving stations attached to the same discharge device, thus making this solution expensive and space consuming.

U.S. Pat. No. 5,890,346 discloses a packaging machine having a rotating device for selecting different articles to be packed. The rotating device in this reference is a dispenser for dispensing CD's to a packing machine, the machine hereby being able to pack different CD's in the same process.

EP 0 744 345 A1 discloses a method and apparatus for packing articles. The apparatus comprises a stacking station having four stacking shafts being arranged rotatably around an axis of symmetry. The stacking station may be rotated so as to move a desired shaft into a position from which it may receive articles. When a shaft is full the stacking station is turned and the articles plied up in the full stacking shaft are removed and packed.

U.S. Pat. No. 3,888,363 discloses an indexing stacker having four compartments. When a stack of a predetermined number of articles is formed in a compartment, the stacker is rotated so that a new and empty compartment is moved into a receiving position.

U.S. Pat. No. 1,600,958 discloses a counting and stacking machine. The articles are caused to drop evenly into the stacker by providing an upwards inclination of the conveyor belts used for conveying the articles. When a predetermined number of articles have been received by the stacker, the stack is released to a conveyor, and the stack of articles is moved away.

It is desirable to provide a discharge device which saves space and at the same time ensures a certain orientation of the articles being discharged since this would cause the articles to be discharged, stacked and packed in a desired manner.

### DESCRIPTION OF THE INVENTION

It is an object of the present invention to provide a discharge device for discharging articles into a stack of articles, the discharge device ensuring that the articles are stacked with a certain desired orientation.

It is a further object of the present invention to provide a discharge device which saves space and which is cheap to manufacture.

It is an even further object of the invention to provide a discharge device making it possible to save time when stacking and packing articles.

It is an even further object of the invention to provide a method of operating a discharge device according to the invention.

Thus the present invention provides a discharge device for a conveyor system for conveying articles, the conveyor system comprising a main conveyor, the articles having a lower surface being supported by an upper surface of the discharge device during at least a part of the discharge, the discharge device comprising

means for discharging articles from the main conveyor,

means for holding articles being discharged in a holding position and in a holding orientation, so as to control the orientation of said articles during at least a part of the discharge,

at least two receiving stations for receiving articles being discharged, and

means for moving at least one of said receiving station(s) into a receiving position from which it is capable of receiving an article being discharged,

wherein the device has a first direction being substantially vertical when the device is in an operating position and a second direction beinq substantially perpendicular to said first direction,

the holding means being movable between a supporting position in which at least a part of the lower surface of an article may be supported, so as to prevent articles from moving in the first direction, and a non-supporting position in which said surface may not be supported so as to allow the articles to move in said direction, the discharge device further comprising means for moving the holding means swiftly between said two positions.

At least some of the articles being discharged may be of substantially homogeneous size and shape. It may be e.g. CD's, video cassettes, book packages or the like. It is preferably items that are substantially flat, such as CD's. The discharge device may be adapted to discharge a number of the above mentioned kinds of articles. This will be described further below.

The means for discharging the articles from the main conveyor may comprise one or more tiltable trays and/or one or more conveyor belts having a conveying direction being substantially perpendicular to the conveying direction of the main conveyor. Alternatively or additionally it may comprise actuator means, the actuator means preferably having one or more pistons being driven electrically, pneumatically and/or mechanically, and/or in any other suitable way.

The holding means is preferably one or more physical barriers, such as one or more plates or arms, the barrier(s) preventing the articles from moving in a substantially vertical direction, i.e. using the gravitational force. But it may alternatively or additionally be any other suitable kind of holding means, such as gripping means for gripping the articles, magnetically holding means for holding articles being made from a magnetisable material and/or holding means using suction, e.g. by means of pressurised air, for holding the articles.

In case the articles are substantially flat articles, such as CD's, the holding orientation is preferably an orientation where one of the larger surfaces faces a downwards direction. In this case it may preferably be ensured that the articles maintain this orientation during the remaining part of the discharge, i.e. when the holding means is shifted to the non-supporting position. Thus, the articles may be stacked in such a way that a larger surface of one article faces a larger surface of a neighbouring article.

The moving means for moving the receiving station(s) into a receiving position preferably comprises one or more pistons being operated mechanically, pneumatically and/or in any other suitable way, or it may be e.g. electrically actuated. The receiving stations may be moved linearly, rotationally and/or in any other suitable way.

When a receiving station is in the receiving position it is ready to receive an article being discharged. Preferably, only one receiving station at a time is in the receiving position. In this case an article being discharged may be moved to this receiving station only.

The first direction is preferably the direction along which the articles are stacked. In a preferred embodiment the articles are stacked in a substantially vertical direction, thereby making use of the gravitational force.

When the holding means is in the supporting position it preferably engages with an article being discharged in such a way that the article is prevented from moving in the first direction. In a very preferred embodiment the article is prevented from moving past the holding means. It is most preferably prevented from moving by means of the gravitational force in a substantially vertical direction.

However, the holding means may also be in the supporting position when no article is present nearby, so that no article may be engaged with the holding means.

When the holding means is in the non-supporting position articles are allowed to pass the holding means (if any article is present nearby). As mentioned above, the holding means may also be in the non-supporting position when no article is positioned nearby.

The moving means for moving the holding means preferably comprises one or more pistons being driven in any suitable way as previously described, or it may be e.g. electrically actuated.

It is necessary to move the holding means swiftly from the supporting position to the non-supporting position to ensure fast discharging and stacking of the articles, as well as to ensure that the holding means inflict on articles as little as possible. Since the movement is swift, the friction between the article and the holding means is dynamic friction which is less than the stationary friction, and the force of the friction does not increase as the velocity increases. This will constitute that faster movement of the holding means equals less infliction of the article.

In a preferred embodiment of the invention only a small fraction of an article being discharged is supported by the holding means when the holding means is in the supporting position.

As it is preferred to have as little as possible infliction of the articles by the holding means, and this is partly done by moving the means with a high velocity, it is preferred to have the means move as little as possible, this will make it an advantage to let the holding means support only a small fraction of the articles at the edges of the articles as the holding means hereby is to be moved as little as possible to go from a supporting position to a non-supporting position.

This could be done by supporting the article at two edges by means of two narrow arms that support each their edge. This way of supporting the article will make it easy to move the supporting means, here the narrow arms, swiftly and without influencing the article substantially. If the arms are placed on opposite sides of the articles and moved in opposite directions during the change from a supporting position to a non-supporting position this will further decrease the influence on the article. The arms could, alternatively, be moved pivotally similarly to the way a trapdoor is operated. In this case the support provided by the holding means to the article is removed almost instantly when the ‘trapdoor’ is released.

It is ensured that the articles maintain their orientation if the two arms are moved substantially concurrently. If the arms, on the other hand, are not moved concurrently the articles may start rotating when the arm being the first to start moving commences this movement. Thereby the orientation of the articles is altered and can thus not be maintained.

In a further embodiment of the discharge device an article, being in the holding position, is characterised by

a first area defined as a projection of said article on a plane substantially perpendicular to the first direction,

a second area defined as the sum of the area of two projections on two planes substantially parallel to the first direction and being substantially perpendicular to each other,

the first area being larger than the second area.

This could indicate, e.g., that the article is a flat item like a CD-cover, compact cassette, video tape, book parcel or a flat box like a chocolate box or a gift box. The invention is not limited to these cases but have advantages according to these types of boxes as they are normally stacked in large numbers and that it is wanted to have these types of boxes dropped from the discharge point to the stack in a flat manner, so as to minimise the damage to the boxes and their contents.

In a preferred embodiment of the invention the first area is at least twice as large as the second area or the first area is at least three times as large as the second area or even the first area is at least four or five times as large as the second area.

In many cases the importance of dropping the articles in a flat manner increases as the thickness of the articles is decreasing.

In an embodiment of the present invention each article being conveyed by the conveyor system belongs to a group of articles, the articles within a certain group being of substantially homogeneous size and shape. In this case each receiving station is adapted to receive articles belonging to a specific group of articles.

The groups of articles could, e.g., be CD's, video cassettes, tape cassettes, books, etc. Thus, the discharge device according to the invention may be adapted to discharge, e.g., CD's as well as video cassettes, tape cassettes, and books. In this case at least one of the receiving stations will be of a size and shape which is suitable for receiving CD's, at least one receiving station is of a size and shape which is suitable for receiving video cassettes, etc. When an article is being discharged and a receiving station is accordingly being selected, the selected receiving station will in this case be one which is suitable for receiving the specific kind of article which is currently being discharged.

In one embodiment all the articles being conveyed by the conveyor system belongs to the same group of articles. In this case all the articles being conveyed may thus be CD's, video cassettes, tape cassettes, books, or any other suitable kind of articles. In this embodiment all the receiving stations a preferably substantially identical.

In a further preferred embodiment the at least two receiving stations are arranged circularly around an axis of symmetry extending in a direction substantially parallel to the first direction, in which case the movement of the receiving station(s) into the article receiving position is a rotating movement around said axis of symmetry.

As an example this could be made with a circular disk rotating around an axis perpendicular to the disk and going through the centre of the circle, the receiving stations being placed along the edge of the disk. But also other ways of making this is to be used, such as a wire frame between the disk and a centre part, or a circular disk placed in between the stations.

These receiving stations may preferably be arranged about the axis of symmetry with substantially equal mutual angular spacing.

Such an equal spacing has advantages as to easy control of the rotation, as the device only has to rotate equal portions to shift from one receiving station to another. Also the load of the rotating part will be homogenous.

The number of receiving stations may range from two to as many as wanted but in a preferred embodiment of the invention the device is made with six receiving stations, wherein the mutual angular spacing is approximately 60°.

But also other numbers may be preferred such as eight receiving stations, wherein the mutual angular spacing is approximately 45°, or ten receiving stations, wherein the mutual angular spacing is approximately 36°.

In another preferred embodiment the device comprises four receiving stations, wherein the mutual angular spacing is approximately 90°.

In an embodiment of the invention it is desired to have a flexible and uneven spacing between the stations. This way it is possible to remove a station and later add the station to the device in a new place. Such a device may be a circular rotatable disk where the stations are limited to being placed along the edge of the disk, but where it is possible to place them anywhere along this edge.

Each receiving station, having a stacking length, preferably comprises

a bottom surface,

a first coming position being the position of the upper surface of the last received article or, in case the receiving station is empty, the position of the bottom surface,

an open upper end for entering articles to the receiving station, and

guiding means for guiding articles from the open upper end to the first coming position,

wherein the received article is entered from the holding means being in the non-supporting position, through the open upper end, and is moved due to the gravitational force in a substantially downwards direction, guided by the guiding means, until the article's lower surface is in the first coming position, the article maintaining the holding orientation during this operation.

In one embodiment the receiving station is made from plate material which is bent in a form where the particular article which is to be discharged has a cross section fitting inside the station with sufficient spacing between the station and the article to allow the article to slide freely. In another embodiment the receiving station is made from elongated string or other profiles that are joined to make a number of guiding points so that the article to be discharged in the station is sliding along the strings or profiles and is guided hereby.

Preferably, sufficient space is provided between the station and the article that a package may be mounted in between the two. In this embodiment the articles may be stacked and packed in the package in one operation, thus saving time when the articles are to be packed as well as stacked. Further, when the package within the station is full it may be removed when the station is not in the receiving position.

The guiding means may be one or more substantially closed walls surrounding the receiving station, the walls may be substantially firm or they may be substantially resilient, such as walls made from a fabric or a soft/resilient plastic material. Or it may be one or more poles extending in the direction of movement of the articles along the sides of the receiving station. Or it may be any other suitable kind of guiding means.

Further, the device preferably comprises position sensing means for sensing the position of the first coming position of at least the receiving station being in the article receiving position, if any station is in the article receiving position.

The sensing means is detecting how many articles there are in a receiving station and whether or not the station is full. The so-called first coming position is the top surface of the top article in the station if the station is not empty. If this position reaches the top level, the articles must be discharged into another receiving station. Also the sensing means may detect exactly how many articles there are in the receiving station and compare this number with an amount supposed to be there or a maximum value.

The position sensing means preferably comprises at least one photo cell.

Alternatively or additionally, the sensing means may comprise an ultra sound device, electromagnetic device, a mechanical device and/or a laser device.

In a preferred embodiment the device further comprises station sensing means for sensing whether a receiving station is in the article receiving position. This will indicate when it is possible to discharge an article to a receiving station. It is further preferred to have sensing means which is able to identify the station so as to verify if it is the wanted station.

This sensing means preferably comprises at least one photo cell but in another preferred embodiment the sensing means may comprise an ultra sound device, electromagnetic device, barcode reader, a mechanical device and/or a laser device.

In a preferred embodiment the discharge device comprises a logical unit for controlling the operation of the discharge device. This unit could be a PLC unit, a PC or a similar computer system, but it may also include other logical units, such as a custom made system.

The means for moving the holding means of the device may in a preferred embodiment comprise at least one pneumatic actuator and/or at least one hydraulic actuator and/or at least one electrical actuator.

In the embodiment using a pneumatic actuator this may be a short piston actuator for moving the supporting means from the supporting position to the non-supporting position, as this type of actuator has a very fast moving possibility.

The holding means may be pivotally movable between the supporting position and the non-supporting position. In this case the holding means is preferably shaped similarly to a trapdoor, and the pivotal movement is made in such a way that the ‘trapdoor’ is released when the holding means is moved from the supporting position to the non-supporting position. This ensured a very swift shift from the supporting to the non-supporting position. since the support is almost instantly removed from the article when the ‘trapdoor’ is released.

Each article being conveyed by the conveyor system may be provided with a machine readable code, in which case the discharge device further comprises

means for reading said machine readable codes and producing an output accordingly, and

means for controlling the means for moving at least one of the receiving station(s) into an article receiving position in accordance with information contained in the machine readable code of an article so that a desired receiving station may be moved into the article receiving position so as to receive said article.

The reading means may comprise a bar code scanner, in which case the machine readable codes of the articles comprises a bar code. Alternatively or additionally, the machine readable codes may comprise radio frequency identification (RFID) tags and/or any other suitable kind of machine readable code, and the reading means is accordingly adapted to read the machine readable code in question.

The machine readable code may comprise information relating to the size and/or shape of the article, the group to which the article belongs, the final destination of the article, special handling instruction (e.g. ‘fragile’, ‘this side up’, etc.) and/or any other suitable information relating to the article. The receiving station is selected in such a way that the information of the machine readable code is taken into consideration. Thus, a receiving station may be selected, e.g., which is suitable for receiving the kind of article which is currently being discharged, and which may contain other articles destined for the same final destination.

The controlling means may comprise a central processing unit (CPU) and/or any other suitable computing means. It is preferably adapted to communicate with the means for moving the receiving stations into the article receiving position and with the reading means in order to ensure that the receiving station is moved in accordance with the information contained in the machine readable code.

According to another aspect of the invention there is provided a method for discharging an article being conveyed by a conveyor system, the conveyor system comprising a main conveyor, and at least one discharge station as it is described above, the method comprising the steps of

transferring the article from the main conveyor to one of the at least one discharge station(s),

holding the article in the holding position and holding orientation,

selecting one of the at least one receiving station(s),

determining whether the selected receiving station is in the article receiving position,

optionally moving the selected receiving station into the article receiving position, and

shifting the holding means position from the supporting position to the non-supporting position so as to allow the article to move in a direction substantially parallel to the first direction, and so as to transfer the article to the selected receiving station.

An article may be transferred by activating the tilting mechanism of a tiltable tray, and/or by activating a conveyor belt being arranged on a conveying cart of the main conveyor, the conveyor belt having a conveying direction being substantially perpendicular to the conveying direction of the main conveyor. Alternatively or additionally it may be pushed from the main conveyor to the discharge device by pushing means which may be activated by electrical and/or pneumatic and/or hydraulic means and/or by any other suitable means. The article may even be transferred manually.

The selection may be based on different criteria such as which article receiving station(s) is/are full/not full. This information may be obtained e.g. by using one or more video cameras, by counting the amount of articles entering each receiving station and/or in any other suitable way, including an operator supervising the discharge device.

Alternatively or additionally, the selection may be based on which article receiving station corresponds to a certain final destination (such as a certain customer wanting a certain composition of articles). In this case the selection may be based on information from a machine readable code, such as a bar code, a transponder or the like, each article being provided with a unique machine readable code. Alternatively or additionally the selection may be performed manually by an operator deciding which article receiving station is to be used.

The determination may be performed by e.g. one or more video cameras, one or more photo cells (wherein the line of detection may be broken e.g. when no article receiving station is in the article receiving position) and/or in any other suitable way, including manually by an operator supervising the device.

Alternatively or additionally, the selection may be based on the size and/or shape of the article.

The selected receiving station may be moved by hydraulic, electrical, pneumatic and/or any other suitable means. Alternatively or additionally, it may be moved manually.

The holding means may be shifted by hydraulic, electrical, pneumatic and/or any other suitable means. Alternatively or additionally, it may be shifted manually.

In a preferred embodiment the step of holding the article in the holding position and holding orientation is performed by supporting only a fraction of the article.

The method may yet further comprise the step of orientating the article in the holding position so that when,

a first area defined as a projection of said article on a plane substantially perpendicular to the first direction,

a second area defined as the sum of the area of two projections on two planes substantially parallel to the first direction and being substantially perpendicular to each other,

the article is orientated in such a way that the first area is larger than the second area.

Hereby the articles are made to stack flat against each other.

In another preferred embodiment the method further comprises the step of orientating the articles in the holding position in such a way that they are orientated with the largest side being perpendicular to the first direction.

In a preferred embodiment of the method the step of optionally moving the selected receiving station into the article receiving position is performed by rotating the at least two receiving stations around an axis being substantially parallel to the first direction, so as to position at least one of the at least two receiving stations in the article receiving position.

Further the method may comprise the steps of

keeping the article in the holding position, and

shifting the holding means from the supporting position to the non-supporting position, in a way and speed that will make the article keep its orientation, so that when the article is not supported it will be forced downwards, substantially keeping its orientation until it is stopped at a first coming position, being the position of the upper surface of the last received article or, in case the receiving station is empty, the position of a bottom surface of the receiving station, wherein the article is guided by guiding means of the receiving station during the fall from the holding position to the first coming position.

The article is kept in the holding position in a desired orientation. If the holding means is shifted swiftly from the supporting position to the non-supporting position it is ensured that this desired orientation is maintained when the article is subsequently moved, by means of gravity, to the first coming position. If the receiving station is empty the first coming position is a bottom surface, preferably defining the bottom of the receiving station. Otherwise it is the upper surface of the last received article. Thus, the articles are stacked, one on top of the other.

In a further preferred embodiment the method comprises the step of sensing by means of a sensing means if a receiving station, such as the receiving station being in the article receiving position, is full and thereby is unable to receive further articles. If the selected receiving station is not in the article receiving position the holding means remain in the supporting position until the selected receiving station is in the article receiving station. This way it is ensured that the articles always end up in an article receiving station, i.e. no articles are allowed to fall between two article receiving station and thereby maybe end up on the floor or in a position where the device may be jammed and/or even damaged.

Each article being conveyed by the conveyor system may be provided with a machine readable code, the machine readable code containing information relating to the article, in which case the step of selecting one of the at least one receiving station(s) comprises the steps of

reading the machine readable code of an article being discharged, and

selecting one of the at least one receiving station(s) based on at least part of the information contained in the machine readable code.

As described above the information contained in the machine readable code may be selected from the group consisting of

the size of the article,

the shape of the article,

the final destination of the article.

Thus, a discharge device is provided which saves space, since several discharge stations are attached to one discharge device. Further, the disclosed discharge device is simple in structure and compact in size, thereby also saving manufacturing costs. Even further the disclosed discharge device makes it possible to perform stacking and packing in one operation, thus saving time for the user.

### DESCRIPTION OF THE FIGURES

FIG. 1 is an isometric view of an embodiment of the invention with a chute for guiding the articles, the discharge device having six receiving stations,

FIG. 2 is a top view of the embodiment of FIG. 1, and

FIG. 3 is an isometric view of another embodiment of the invention, the discharge device having four receiving stations.

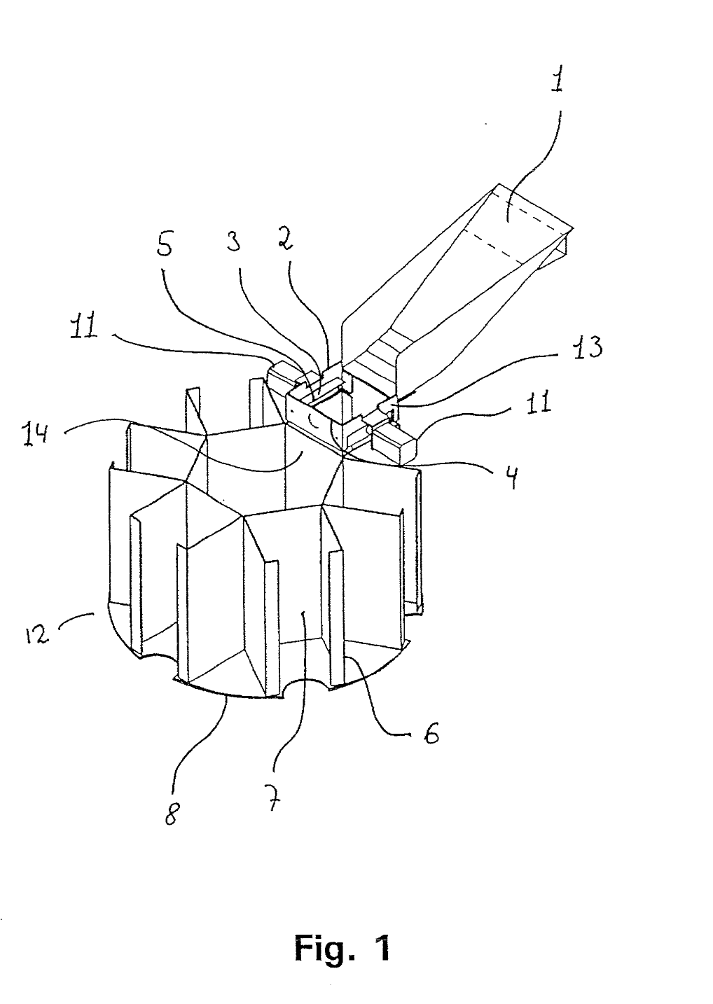

FIG. 1 shows a discharge device according to the invention, the discharge device having a chute 1, holding means 2, and a receiving device 12.

The chute 1 is made from a plate material that is formed so that an article placed at the top end of the chute 1 is forced by gravity to the lower part of the chute 1, thus the surface of the chute 1 is smooth and has edges for guiding the articles.

The holding means 2 comprises a frame part 13, two supporting means 3 for supporting the article in the holding means 2, two pneumatic cylinders 11 for moving the supporting means 3 from a supporting position to a non-supporting position, an article stop plate 4 for stopping the movement of the article coming from the chute 1, and optionally position sensing means for determining the position of a receiving station 7 and optionally station sensing means for determining which receiving station is in the receiving position.

The receiving device 12 comprises a frame part being a circular disk 8 and six receiving stations 7, one being in the receiving position 14. Each receiving station has guiding means 6 for guiding the articles from the holding means.

The receiving device 12 is placed rotatably around an axis going through the centre of the circular disk 8 and being perpendicular to said disk 8. The holding means 2 is placed above the receiving station 7 being in the article receiving position 14, so that when the supporting means 3 is in the non-supporting position the article being in the holding means 2 is guided into the receiving station 7. The chute 1 is placed so that when the article exits the chute 1 it hits the stop plate 4 of the holding means 2.

The supporting means 3 is build with two pneumatic actuators 11 one on each side of the chute 1. The articles slide down the chute 1 being stopped by a stop plate 4 and supported by the supporting means 3, as the article now is situated with the correct orientation and in the correct position the supporting means 3 is swiftly moved from the supporting position to the non-supporting position by means of the pneumatic cylinders 11 which moves the two supporting means 3, being two narrow plates 5, swiftly to the sides.

The article is hereafter forced by gravity and guided by the guiding means 6 into and down to the receiving station 7. After this the supporting means 3 is shifted to the supporting position again and the holding means 2 is ready to receive the next article.

A package, such as a standard size card board box may easily be mounted in at least one of the receiving stations 7. Thus, when the articles are discharged they are stacked and packed at the same time directly into the box. Thereby the number of operations are limited and time is saved. The stacking and packing operation is thereby simplified.

In this embodiment of the invention there are six equally spaced receiving stations 7, placed on a circular disk 8 along the edge of said disk 8.

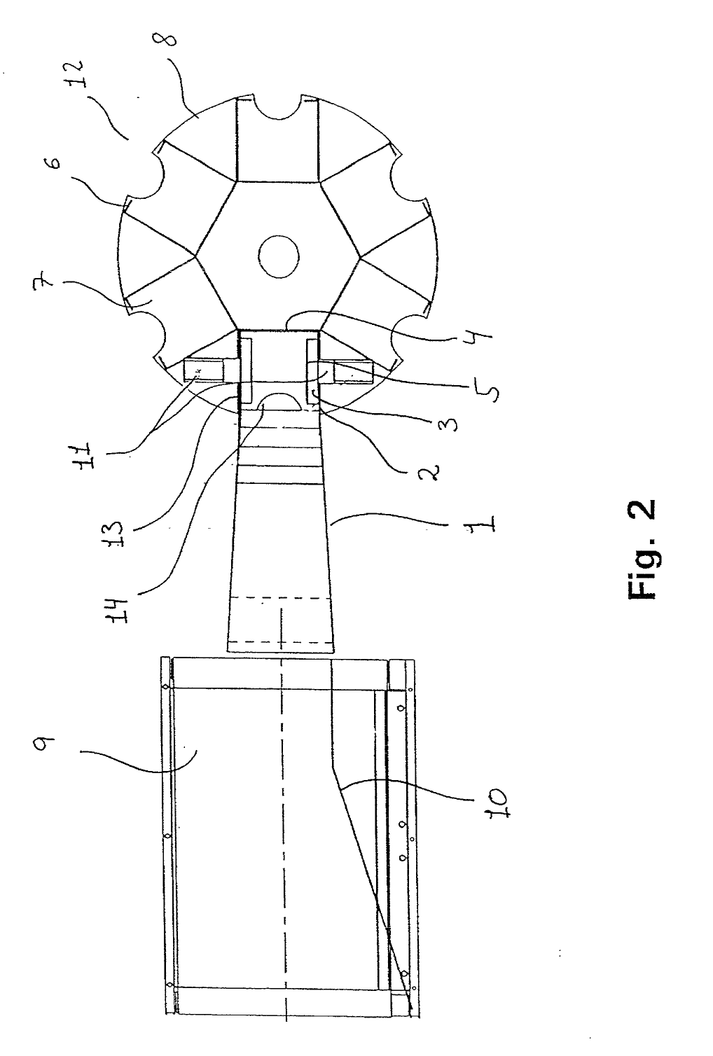

FIG. 2 shows the embodiment of the invention as it is shown in FIG. 1, and further having a conveyor belt 9 for transporting the articles from the main conveyor to the device. The articles are guided by a guide arm 10 on the conveyor belt 9 to enter the chute 1 in a suitable way. The remaining part of the discharge is performed as described above in connection with FIG. 1.

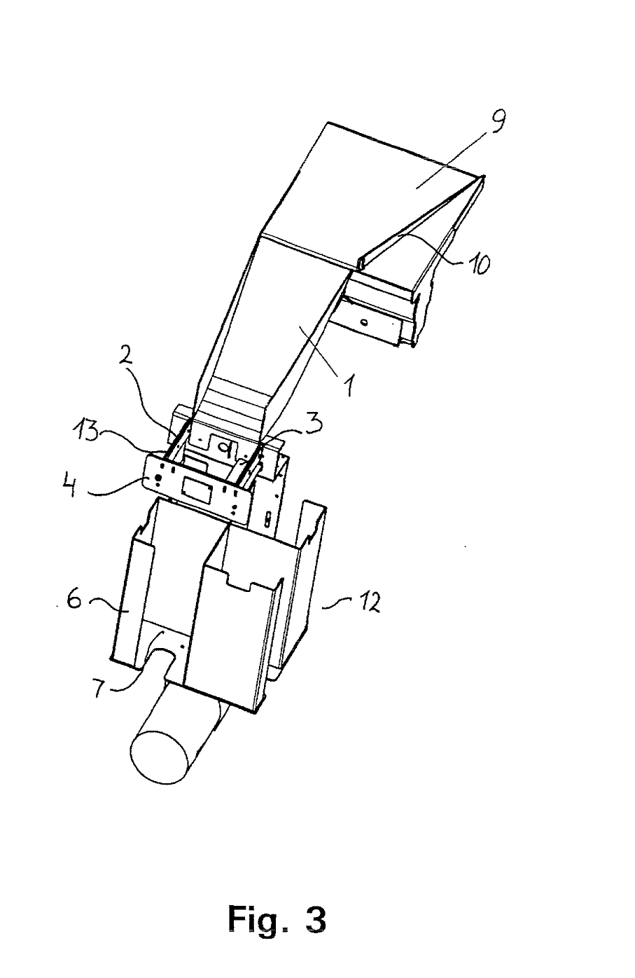

FIG. 3 shows another embodiment of a discharge device according to the invention, the receiving device 12 in this case comprising four receiving stations 7. The device is operated very similarly to the way described above. However, the holding means 2 is in this case provided with supporting means 3 being mounted pivotally on the frame part 13. The supporting means 3 is thus moved between the article supporting and the non-supporting positions by means of a pivotal movement, similarly to the way in which a trapdoor is operated. When an article is received by the holding means 2 the presence of the article is detected by a photo cell (not shown). Then the supporting means 3 is activated, i.e. moved from the article supporting to the non-supporting position. This is done by releasing the ‘trapdoor’ which for all practical purposes means that the supporting effect of the supporting means 3 is almost instantly removed. Thus, the article will maintain the orientation which it has obtained while it was retained by the holding means 2.

1. A discharge device for a conveyor system for conveying articles, the conveyor system comprising a main conveyor, the articles having a lower surface being supported by an upper surface of the discharge device during at least a part of the discharge, the discharge device comprising
means for discharging articles from the main conveyor,
means for holding articles being discharged in a holding position and in a holding orientation, so as to control the orientation of said articles during at least a part of the discharge,
at least two receiving stations for receiving articles being discharged, and
means for moving at least one of said receiving station(s) into a receiving position from which it is capable of receiving an article being discharged,
wherein the device has a first direction being substantially vertical when the device is in an operating position and a second direction being substantially perpendicular to said first direction,
the holding means being movable between a supporting position in which at least a part of the lower surface of an article may be supported, so as to prevent articles from moving in the first direction, and a non-supporting position in which said surface may not be supported so as to allow the articles to move in said direction, the discharge device further comprising means for moving the holding means swiftly between said two positions.

2. A discharge device according to claim 1 wherein only a small fraction of an article being discharged is supported by the holding means when the holding means is in the supporting position.

3. A discharge device according to claim 1 wherein an article, being in the holding position, is characterised by
a first area defined as a projection of said article on a plane substantially perpendicular to the first direction,
a second area defined as the sum of the area of two projections on two planes substantially parallel to the first direction and being substantially perpendicular to each other,
the first area being larger than the second area.

4. A discharge device according to claim 3 wherein the first area is at least twice as large as the second area.

5. A discharge device according to claim 4 wherein the first area is at least three times as large as the second area.

6. A discharge device according to claim 5 wherein the first area is at least four times as large as the second area.

7. A discharge device according to claim 6 wherein the first area is at least five times as large as the second area.

8. A discharge device according to claim 1 wherein each article being conveyed by the conveyor system belongs to a group of articles, the articles within a certain group being of substantially homogeneous size and shape, and wherein each receiving station is adapted to receive articles belonging to a specific group of articles.

9. A discharge device according to claim 8, wherein all the articles being conveyed by the conveyor system belongs to the same group of articles.

10. A discharge device according to claim 1, wherein the at least two receiving stations are arranged circularly around an axis of symmetry extending in a direction substantially parallel to the first direction, and wherein the movement of the receiving station(s) into the article receiving position is a rotating movement around said axis of symmetry.

11. A discharge device according to claim 10 wherein the receiving stations are arranged about the axis of symmetry with substantially equal mutual angular spacing.

12. A discharge device according to claim 11 comprising six receiving stations, wherein the mutual angular spacing is approximately 60°.

13. A discharge device according to claim 11 comprising four receiving stations, wherein the mutual angular spacing is approximately 90°.

14. A discharge device according to claim 1 wherein each receiving station, having a stacking length, comprises
a bottom surface,
a first coming position being the position of the upper surface of the last received article or, in case the receiving station is empty, the position of the bottom surface,
an open upper end for entering articles to the receiving station, and
guiding means for guiding articles from the open upper end to the first coming position,
wherein the received article is entered from the holding means being in the non-supporting position, through the open upper end, and is moved due to the gravitational force in a substantially downwards direction, guided by the guiding means, until the article's lower surface is in the first coming position, the article maintaining the holding orientation during this operation.

15. A discharge device according to claim 14, further comprising position sensing means for sensing the position of the first coming position at least of the receiving station being in the article receiving position, if any station is in the article receiving position.

16. A discharge device according to claim 15, wherein the position sensing means comprises at least one photo cell.

17. A discharge device according to claim 1, further comprising station sensing means for sensing whether a receiving station is in the article receiving position.

18. A discharge device according to claim 17, wherein the station sensing means comprises at least one photo cell.

19. A discharge device according to claim 1, further comprising a logical unit for controlling the operation of the discharge device.

20. A discharge device according to claim 1, wherein the means for moving the holding means comprises at least one pneumatic actuator.

21. A discharge device according to claim 1, wherein the means for moving the holding means comprises at least one hydraulic actuator.

22. A discharge device according to claim 1 wherein the means for moving the holding means comprises at least one electrical actuator.

23. A discharge device according to claim 1, wherein the holding means is pivotally movable between the supporting position and the non-supporting position.

24. A discharge device according to claim 1, wherein each article being conveyed by the conveyor system is provided with a machine readable code, the discharge device further comprising
means for reading said machine readable codes and producing an output accordingly, and
means for controlling the means for moving at least one of the receiving station(s) into an article receiving position in accordance with information contained in the machine readable code of an article so that a desired receiving station may be moved into the article receiving position so as to receive said article.

25. A discharge device according to claim 24, wherein the reading means comprises a bar code scanner.

26. A discharge device according to claim 24 wherein the controlling means comprises a central processing unit.

27. A discharge device according to claim 24, wherein the machine readable code comprises information relating to the article, the information being selected from the group consisting of
the size of the article,
the shape of the article,
the final destination of the article.

28. A method of discharging an article being conveyed by a conveyor system, the conveyor system comprising a main conveyor, and at least one discharge station according to claim 1, the method comprising the steps of
transferring the article from the main conveyor to one of the at least one discharge stations,
holding the article in the holding position and holding orientation,
selecting one of the at least one receiving stations,
determining whether the selected receiving station is in the article receiving position,
optionally moving the selected receiving station into the article receiving position, and
shifting the holding means position from the supporting position to the non-supporting position so as to allow the article to move in a direction substantially parallel to the first direction, and so as to transfer the article to the selected receiving station.

29. A method according to claim 28, wherein the step of holding the article in the holding position and holding orientation is performed by supporting only a fraction of the article.

30. A method according to claim 28, further comprising the step of orientating the article in the holding position so that when,
a first area defined as a projection of said article on a plane substantially perpendicular to the first direction,
a second area defined as the sum of the area of two projections on two planes substantially parallel to the first direction and being substantially perpendicular to each other,
the article is orientated in such a way that the first area is larger than the second area.

31. A method according to claim 28, further comprising the step of orientating the articles in the holding position in such a way that they are orientated with the largest side being perpendicular to the first direction.

32. A method according to claim 28, wherein the step of optionally moving the selected receiving station into the article receiving position is performed by rotating the at least two receiving stations around an axis being substantially parallel to the first direction, so as to position at least one of the at least two receiving stations in the article receiving position.

33. A method according to claim 28, further comprising the steps of
keeping the article in the holding position, and
shifting the holding means from the supporting position to the non-supporting position, in a way and speed that will make the article keep its orientation, so that when the article is not supported it will be forced downwards, substantially keeping its orientation until it is stopped at a first coming position, being the position of the upper surface of the last received article or, in case the receiving station is empty, the position of a bottom surface of the receiving station, wherein the article is guided by guiding means of the receiving station during the fall from the holding position to the first coming position.

34. A method according to claim 28 further comprising the step of sensing by means of a sensing means if a receiving station, such as the receiving station being in the article receiving position, is full and thereby is unable to receive further articles.

35. A method according to claim 28 wherein the holding means remain in the supporting position if the selected receiving station is not in the article receiving position.

36. A method according to claim, 28 wherein each article being conveyed by the conveyor system is provided with a machine readable code, the machine readable code containing information relating to the article, and wherein the step of selecting one of the at least one receiving station(s) comprises the steps of
reading the machine readable code of an article being discharged, and
selecting one of the at least one receiving station(s) based on at least part of the information contained in the machine readable code.

37. A method according to claim 36, wherein the information contained in the machine readable code is selected from the group consisting of
the size of the article,
the shape of the article,
the final destination of the article.
